(19) United States
(12) Patent Application Publication
(10) Pub. No.: US 2014/0355015 A1
(43) Pub. Date: Dec. 4, 2014

(54) IMAGE FORMING APPARATUS, METHOD OF CONTROLLING THE SAME AND STORAGE MEDIUM

(71) Applicant: CANON KABUSHIKI KAISHA, Tokyo (JP)

(72) Inventor: Tsuyoshi Yokomizo, Tokyo (JP)

(21) Appl. No.: 14/286,215

(22) Filed: May 23, 2014

(30) Foreign Application Priority Data
May 31, 2013 (JP) 2013-116248

(51) Int. Cl. H04N 1/60

(52) U.S. Cl. CPC H04N 1/603
USPC 358/1.9

(57) ABSTRACT

An image forming apparatus reads an image, generates image data of the image, and forms an image on a sheet based on image data. The apparatus corrects a tone of an image based on an image read in the reading, the image being an image of a sheet formed in the forming, based on image data for tone correction after a preparation operation for respectively forming images on a predetermined number of sheets has been executed. The apparatus determining whether or not a remaining number sheets used in the forming is greater than or equal to a predetermined number and performs a display, in accordance with the result of the determining, in order to confirm with a user whether or not to execute the preparation operation.

### BACKGROUND OF THE INVENTION

1. Field of the Invention

The present invention relates to an image forming apparatus having a function for correcting a tone of image data, a method of controlling the same, and a storage medium.

2. Description of the Related Art

Regarding conventional copying machines, digital copying machines that apply digital processing to image data of an original scanned by a scanner, and print by transferring that image data to a printer unit are mainstream. With copying machines of this kind of configuration, when an original is copied when tone characteristics of the image data scanned by the scanner, and tone characteristics when printing to a sheet with a printer unit are not consistent, the tone characteristics of the printed original are impaired. Thus, there is an automatic tone correction function which is a function for adjusting the tone characteristics of printed materials when copying an original.

Explanation will be given for this automatic tone correction function. Image data of a tone measurement chart is generated, and the tone measurement chart is printed with a printer unit based on that image data. Image data is obtained by scanning the printed tone measurement chart with a scanner. Difference data for tone correction of image data printed by the printer unit is calculated by comparing image data obtained by scanning the chart, and image data of the original tone measurement chart. A conversion table for tone correction of image data output to the printer unit is generated by repeating this kind of progression a number of times. By using the conversion table for tone correction generated in this way, it becomes possible to reproduce with a printer unit the tone of an original read in by a scanner.

A method for correcting image data that adds a difference in the paper used when printing in addition to this kind of method has been proposed, and also, in Japanese Patent Laid-Open No. 2001-119594, an automatic tone correction function is recited.

The previously described automatic tone correction presumes that conditions when the printer prints image data are stable. However, there are cases where a density variation occurs somewhat between a first few printed materials, and printed materials after these due to the environment in which the printer is used. This is because a fixing temperature when the printer prints differs depending on temperature variation due to the place in which the printer is placed, the time period of the printing, or the like. Accordingly, in order to accurately perform automatic tone correction, it is advantageous that it be performed under conditions for which density variation does not occur due to differences in the fixing temperature. For this reason, stabilizing a fixation process including a fixing temperature at the time of printing the chart for tone correction by printing charts for process stabilization consecutively for a plurality of sheets prior to printing the chart for tone correction for automatic tone correction can be considered.

A case in which the paper runs out during printing of charts for process stabilization, charts for tone measurement, or the like is considered. In such a case, after paper is replenished, it is necessary to print the charts for process stabilization and to print the tone measurement charts once again from the start, and the printing of the chart performed before the paper ran out was a waste. Also, because it takes several tens of seconds until printing processing is initiated after the paper is replenished when there is a paper outage, there is a problem in that it takes time for execution of the automatic tone correction.

### SUMMARY OF THE INVENTION

An aspect of the present invention is to eliminate the above-mentioned problems with the conventional techniques.

A feature of the present invention is to provide a technique in which a paper outage situation occurring during image forming for process stabilization, image forming for tone measurement, or the like, is prevented.

According to an aspect of the present invention, there is provided an image forming apparatus. The apparatus comprises a reading unit configured to read an image and generate image data of the image, an image forming unit configured to form an image on a sheet based on image data, a control unit configured to cause the image forming unit to form an image based on image data for tone correction after a preparation operation for respectively forming images on a predetermined number of sheets has been executed, a correction unit configured to correct a tone of an image to be formed by the image forming unit, based on image data generated by the reading unit by reading an image of a sheet formed by the image forming unit, a determination unit configured to determine whether or not a remaining number sheets that the image forming unit uses is greater than or equal to a predetermined number, and a display unit configured to perform a display, in accordance with the result of the determination by the determination unit, in order to confirm with a user whether or not to execute the preparation operation.

According to another aspect of the present invention, there is provided a method of controlling an image forming apparatus. The method comprises reading an image and generating image data of the image, forming an image on a sheet based on image data, correcting a tone of an image based on an image read in the reading, the image being an image of a sheet formed in the forming, based on image data for tone correction after a preparation operation for respectively forming images on a predetermined number of sheets has been executed, determining whether or not a remaining number sheets used in the forming is greater than or equal to a predetermined number, and performing a display, in accordance with the result of the determining, in order to confirm with a user whether or not to execute the preparation operation.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a structural cross-section view of an image forming apparatus according to embodiments of the present invention.

FIG. 2 is a block diagram for showing a functional configuration of the image forming apparatus according to embodiments.

FIG. 3 is a top view of an operation unit of the image forming apparatus according to embodiments.

FIG. 4 is a view for showing an example of a screen for performing a setting for automatic tone correction which is displayed on a display unit when a user presses a user setting key of the operation unit.

FIG. 5 is a view for illustrating an example of a setting screen for setting the number of output sheets of test pages which is displayed on the display unit of the operation unit of the image forming apparatus according to embodiments.

FIG. 6 is a flowchart for describing processing for printing charts for process stabilization and tone measurement charts, and generating a conversion table for tone correction based on the tone measurement charts in the image forming apparatus according to a first embodiment.

FIG. 7 is a view for showing an example of a screen displayed on the display unit in the processing of FIG. 6.

FIG. 8 is a flowchart for describing processing for printing charts for process stabilization and tone measurement charts, and generating a conversion table for tone correction based on charts for tone measurement in the image forming apparatus according to a second embodiment of the present invention.

FIGS. 9A and 9B are flowcharts for describing processing for printing charts for process stabilization and tone measurement charts, and generating a conversion table for tone correction based on the charts for tone measurement in the image forming apparatus according to a third embodiment of the present invention.

FIGS. 10A and 10B are flowchart for describing processing for printing charts for process stabilization and tone measurement charts, and generating a conversion table for tone correction based on the charts for tone measurement in the image forming apparatus according to according to a fourth embodiment of the present invention.

### DESCRIPTION OF THE EMBODIMENTS

Embodiments of the present invention will be described hereinafter in detail, with reference to the accompanying drawings. It is to be understood that the following embodiments are not intended to limit the scope of the claims of the present invention, and that not all of the combinations of the aspects that are described according to the following embodiments are necessarily required with respect to the means to solve the problems according to the present invention.

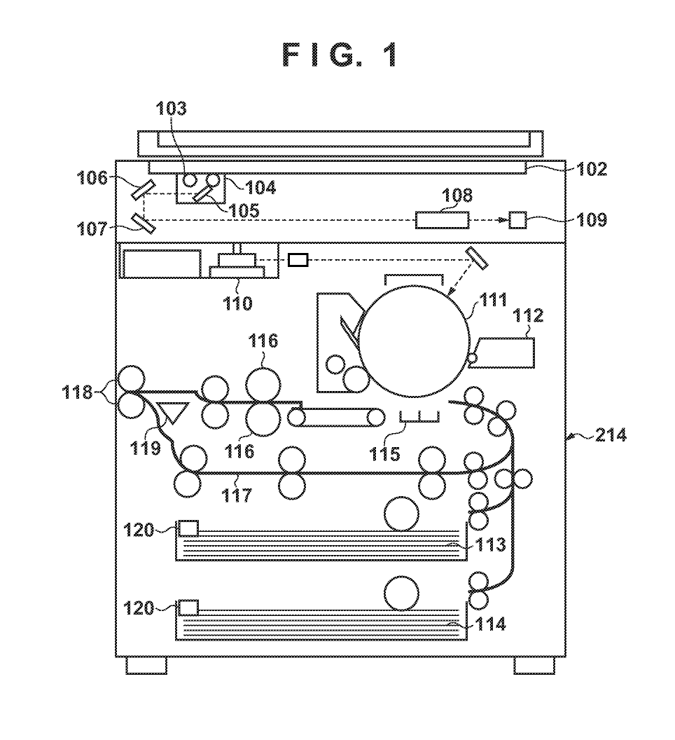

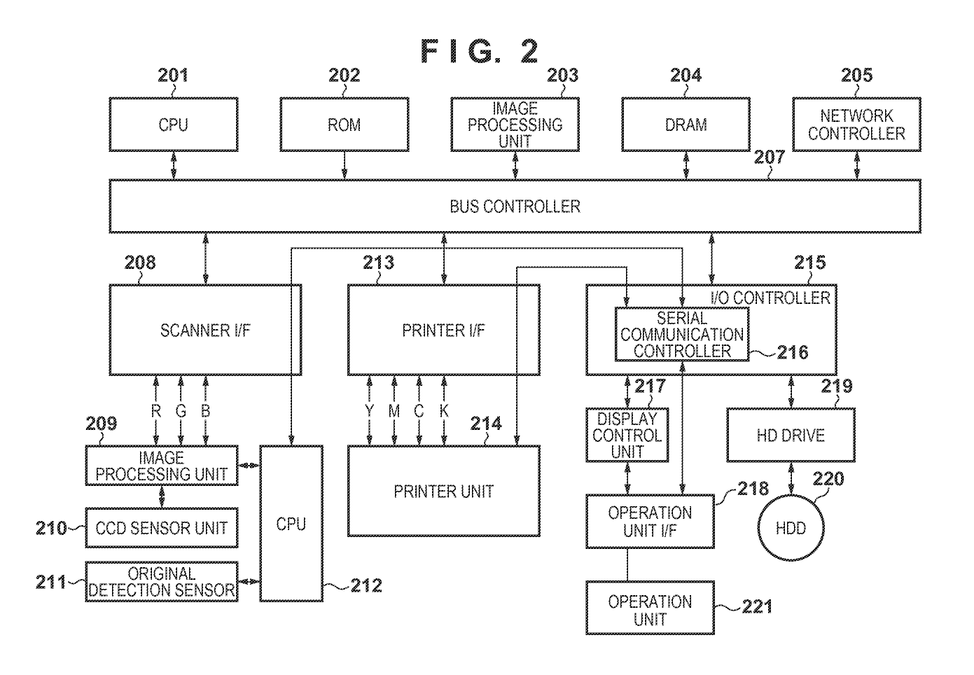

FIG. 1 is a structural cross-section view of an image forming apparatus according to embodiments of the present invention. Also, FIG. 2 is a block diagram for showing a functional configuration of the image forming apparatus according to embodiments.

In the present embodiment, the center of control is a CPU 201. The CPU 201 operates in accordance with a control program are stored in a ROM 202, or a control program loaded into a DRAM 204 via an I/O controller 215 and an HD drive 219 from an HDD 220 by an initialization program stored in the ROM 202.

Below, with reference to FIG. 1 and FIG. 2, explanation will be given for a read operation and a print operation on an image by the image forming apparatus according to embodiments.

An original placed on a contact glass 102 is irradiated by a lamp 103 and is scanned by movement of an optical unit 104 when the original is read. Reflected light from the original is guided by mirrors 105, 106 and 107, and by a lens 108 to a CCD image sensor (hereinafter referred to as the CCD) 109. With this, an image of the original is read by the CCD 109, and is converted into an electrical signal.

This processing is equivalent to reading an original by controlling a CCD sensor unit 210 (corresponding to the CCD 109 of FIG. 1) when a CPU 212 of a scanner shown in FIG. 2 detects the existence of the original with an original detection sensor 211. Image data of an original read by the CCD sensor unit 210 is converted into an RGB signal by an image processing unit 209 by the control of the CPU 212. Then, by the control of the CPU 201, after temporarily being stored in the DRAM 204 via a scanner I/F 208 and a bus controller 207, it is saved in the HDD 220 via the I/O controller 215 and the HD drive 219.

A serial communication controller 216 connects an operation unit 221 and an I/O control 215 via an operation unit I/F 218 and a display controller 217. Also, the serial communication controller 216 connects the I/O controller 215 and a printer unit 214, and the CPU 212 of the scanner. A network controller 205 controls access to a network.

Image data saved in the HDD 220 is read out from the HDD 220 by control of the CPU 201, and temporarily saved into the DRAM 204 in cases where image data saved in the HDD 220 is printed. After that, color space transformation, and the like, such as an RGB->CMYK transformation, etcetera, is performed by an image processing unit 203. After this, the processed image data is transferred to the printer unit 214, which is an image forming unit, via a printer I/F 213.

Image data transferred to the printer unit 214 is converted from image data to a laser beam by a laser unit 110, and is formed as an image on a photosensitive drum 111 by the laser beam emitted from the laser unit 110. The formed image is developed into a toner image by a developer unit 112 for causing toner to be absorbed by static capacitance of the image formed on the photosensitive drum 111. Then, the toner image is transferred by a transferring unit 115 to a sheet fed from a paper feed cassette tray (paper feed tray) 113 or a cassette tray 114. The paper, onto which the toner image is transferred in this way, is sent to fixing units 116, and after the toner image is fixed to the paper, the paper is discharged from the device by rotation of conveyance rollers 118. A flapper 119 is used for switching a conveyance direction of a sheet in order to send the sheet, the front surface of which has been printed, to a double-sided feed path 117 when double-sided printing to the sheet. Reference numeral 120 denotes paper sensors which detect the existence or absence of a sheet in the paper feed cassette tray (paper feed tray) 113, and the cassette tray 114.

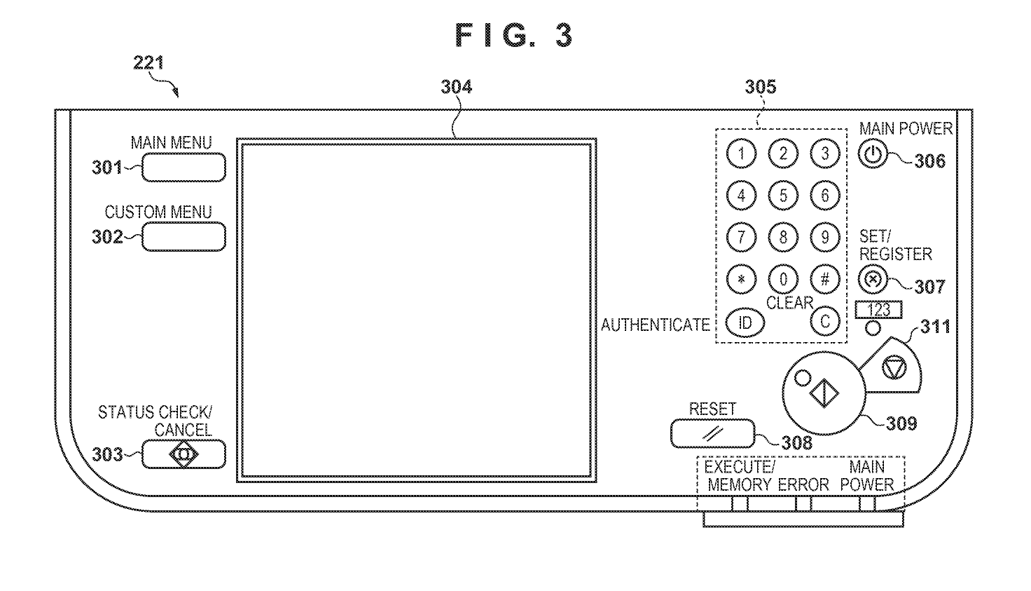

FIG. 3 is a top view of the operation unit 221 of the image forming apparatus according to embodiments.

Reference numeral 301 denotes a main menu key, numeral 302 denotes a custom menu key, and numeral 303 denotes a status check/cancel key. A display unit 304 is provided with a touch panel function in addition to a display function. A numeric keypad 305 is used for inputting various numeric values such as a number of copies, a facsimile number, or the like. A power supply key 306 is used for turning on or off a power of the image forming apparatus. A start key 309 is used for instructing initiation of a copy, a facsimile transmission, or the like. A stop key 311 is used for stopping an operation in progress. Reference numeral 308 denotes a reset key. A user setting key 307 is used when a user registers by performing various settings.

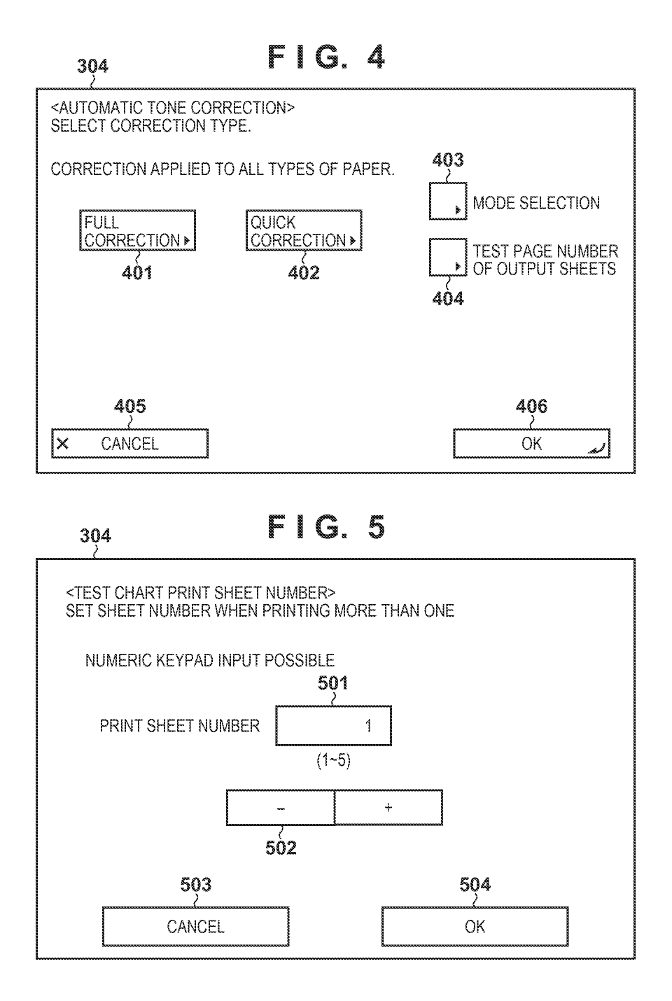

FIG. 4 is a view for showing an example of a screen for performing a setting for automatic tone correction which is displayed on the display unit 304 when a user presses the user setting key 307 of the operation unit 221.

When a “full correction” button 401 is selected and an OK button 406 is pressed, automatic tone correction is instructed. Note, a “quick correction” button 402 is a button for instructing a simple tone correction, and in this case the number of sheets printed for the tone measurement charts is small. A “mode selection” button 403 selects whether to perform processing for reading the tone measurement chart with the CCD sensor unit 210 in the scanner, or whether to perform it with a spectral sensor (not shown) in the printer unit 214. When a “test page number of output sheets” button 404 is pressed, a setting screen for the number of output sheets of test pages of FIG. 5 is displayed. A cancel button 405 is a button for cancelling settings on this screen.

FIG. 5 is a view for illustrating an example of a setting screen for setting the number of output sheets of test charts which is displayed on the display unit 304 of the operation unit 221 of the image forming apparatus according to embodiments.

Here, with a number of sheets printed setting field 501, the number of sheets output (printed) for a chart can be set from 1-5. The number sheets printed may be a number of sheets including the charts for process stabilization and the tone measurement charts, or only the number of sheets of the charts for process stabilization. This number of sheets printed may be input using the numeric keypad 305, or setting may be performed by incrementing or decrementing the numeric value with buttons 502. After inputting the number sheets printed, the input number of sheets is confirmed by pressing an OK button 504, and returning to the automatic tone correction screen of FIG. 4. Also, when a cancel button 503 is pressed, the setting screen for the number sheets printed is terminated, and the automatic tone correction screen on FIG. 4 is returned to.

When the number sheets printed for the test chart is determined in this way, the CPU 201 obtains this number of sheets via the serial communication controller 216 and the I/O controller 215, and saves it to the DRAM 204. Note, the place in which this number of sheets is saved is not limited to the DRAM 204, and may be a non-volatile memory, the HDD 220, or the like.

### First Embodiment

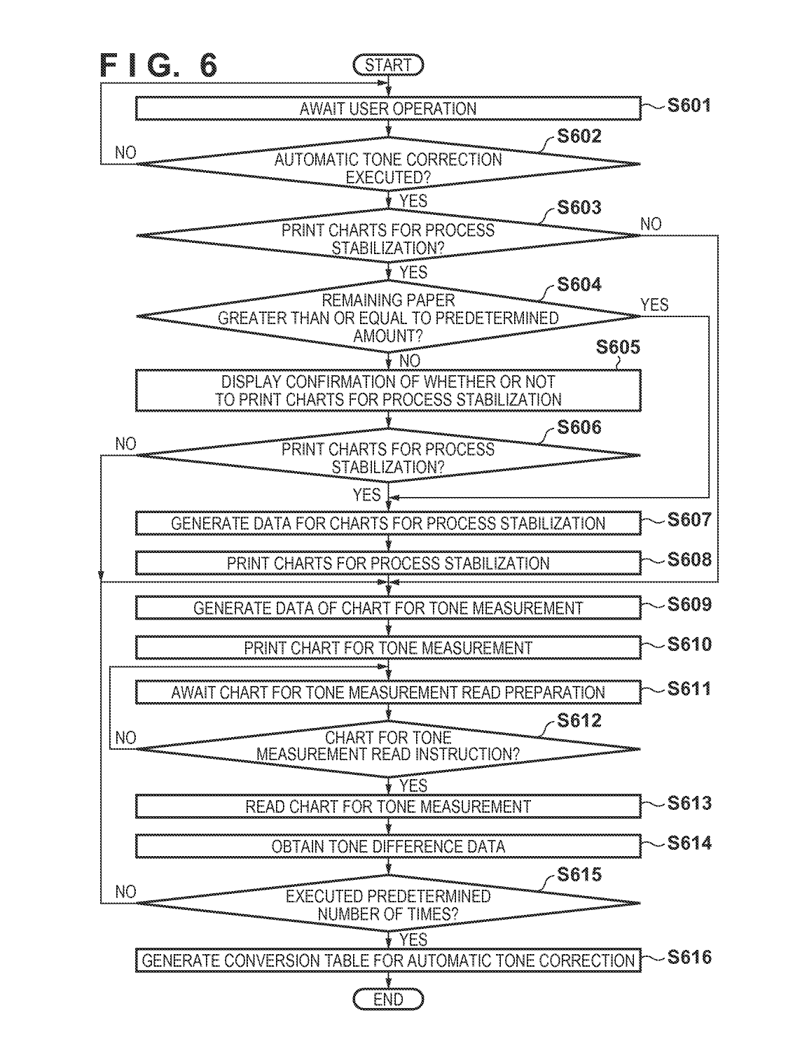

Next, explanation will be given for a first embodiment of the present invention, with reference to the flowchart of FIG. 6.

FIG. 6 is a flowchart for describing processing for printing charts for process stabilization and tone measurement charts, and generating a conversion table for tone correction based on the tone measurement charts in the image forming apparatus according to a first embodiment. Note, the processing shown in this flowchart is achieved by the CPU 201 executing a program stored in the ROM 202, or loaded into the DRAM 204. Note, the printing of the charts for process stabilization is something performed in order to stabilize an image forming process such as a fixation process in the printer unit 214 of the image forming apparatus, and it is executed prior to printing the tone measurement charts.

This processing is initiated by a power of the image forming apparatus being turned on, for example, and firstly, in step S601, the CPU 201 waits for a user operation via the operation unit 221. In step S602, the CPU 201 determines whether or not a user pressed the user setting key 307 of the operation unit 221, and instructed the execution of automatic tone correction with the “full correction” button 401 in the screen (FIG. 4) displayed on the display unit 304. When the execution of the automatic tone correction is instructed, the processing proceeds to step S5603, and the CPU 201 obtains the number of sheets to be printed of the charts for process stabilization set with the screen of FIG. 5 and saved in the DRAM 204. Then, it is determined whether or not the number sheets to be printed is not “0”, i.e. printing of the charts for process stabilization is instructed. If printing of the charts for process stabilization is instructed, the processing proceeds to step S604, and otherwise the processing proceeds to step S609. In step S604, the CPU 201 determines whether or not the remaining amount of paper for printing the charts is greater than or equal to a predetermined amount. The following is an exemplary embodiment of a detection unit for detecting this remaining paper amount.

In cases where a paper feed tray is tilted in order to send paper to the paper feed cassette trays 113 and 114, a number of rotations of a gear for the tilting is counted by a CPU (not shown) of the printer unit 214, and that value is obtained via the printer I/F 213. Here, if the obtained number of rotations of the gear is less than or equal to a predetermined number, it is determined that the remaining amount of paper is greater than or equal to a predetermined amount. Also, another exemplary embodiment of the detection unit for detection of the remaining paper amount is as follows. For example, it may be determined whether or not the remaining amount paper is greater than or equal to a predetermined amount based on whether or not a detected height is greater than or equal to a predetermined height, having detected the height of the paper accommodated in the paper feed tray with a height detection sensor (not shown) prior to tilting the paper feed tray. In step S604, in a case where it is determined that the remaining paper amount is greater than or equal to the predetermined amount, the processing proceeds to step S605 because there is the possibility that not all of the charts for process stabilization and the charts for tone measurement can be printed. In step S605, the CPU 201 displays to the display unit 304 something that confirms whether to print the charts for process stabilization. Also, when it is determined that the remaining paper amount is greater than or equal to the predetermined amount in step S604, the processing proceeds to step S607.

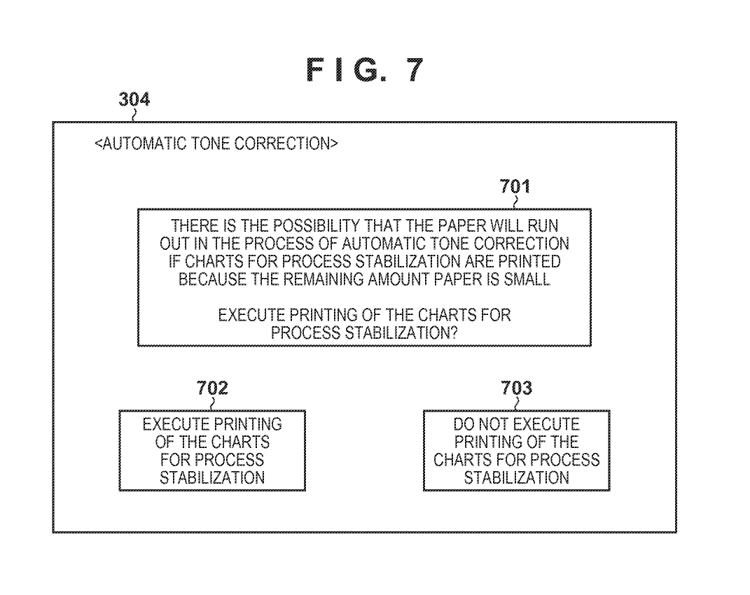

FIG. 7 is a view for showing an example of a screen displayed on the display unit 304 in step S605 of FIG. 6.

In FIG. 7, reference numeral 701 indicates that there is the possibility that the paper will run out in the process of automatic tone correction, i.e. in the process of printing the charts for tone measurement, because the remaining amount paper is small. In response to this, the user can instruct whether or not to execute the printing of the charts for process stabilization with button 702 or 703. Here, the user may supply the necessary number of sheets of paper to the paper feed cassette tray, and press the button 702 to instruct the execution of the printing of the charts for process stabilization. Alternatively, the user may instruct that the printing of the charts for process stabilization be cancelled by pressing the button 703.

Next, the processing proceeds to step S606, and the CPU 201 determines whether or not the user instructed that printing of the charts for process stabilization be executed by pressing the button 702, and in this case the processing proceeds to step S607. Meanwhile, in cases where the user instructed that the printing of the charts for process stabilization not be executed by pressing the button 703, the processing proceeds to step S609. In step S607, the CPU 201 generates image data for the charts for process stabilization in a region of the DRAM 204. Then, the processing proceeds to step S608, and the CPU 201 transfers the image data of the charts for process stabilization generated in the DRAM 204 to the printer unit 214 via the image processing unit 203, the bus controller 207, and the printer I/F 213. Then, with the printer unit 214, the designated the number of sheets of charts for process stabilization are printed.

Next, the processing proceeds to step S609, and the CPU 201 generates the image data of the chart for tone measurement in a region of the DRAM 204. Then, the processing proceeds to step S610, and the CPU 201 prints the image data of the chart for tone measurement generated in the DRAM 204 by transferring it to the printer unit 214 on the same path as in step S608.

When the printing of the chart for tone measurement completes, the processing proceeds to step S611, and the CPU 201 waits for a read instruction for reading the printed chart for tone measurement to be input from the operation unit 221. Here, the user places the printed chart for tone measurement on the contact glass 102, and presses the start key 309 of the operation unit 221. With this, the processing proceeds to step S613 from step S612, and the CPU 201 initiates the reading of the chart for tone measurement placed on the contact glass 102. Here, the CPU 212 of the scanner lights the lamp 103, and reads the image of the chart with the CCD 109 by scanning the chart for tone measurement on the contact glass 102 with movement of the optical unit 104. The CPU 201 stores the image data of the chart for tone measurement read in this way by transferring it to the DRAM 204 via the image processing unit 209, the scanner I/F 208, and the bus controller 207. Then, the processing proceeds to step S614, and the CPU 201 obtains tone difference data by comparing image data of the chart for tone measurement stored in the DRAM 204 in step S613 and image data of the chart for tone measurement generated in the DRAM 204 in step S609, and saves it into the DRAM 204. Then, the processing proceeds to step S615, and the CPU 201 determines whether or not the processing for obtaining the above described tone difference data has been executed a predetermined number of times, and when it is determined that the predetermined number of times have not been executed, the processing proceeds to step S609, but in cases where it is determined that the predetermined number of times have been executed, the processing proceeds to step S616. In step S616, the CPU 201 generates a conversion table for tone correction from the plurality of tone difference data items saved in the DRAM 204. The conversion table for tone correction thus generated is saved in the DRAM 204 by the CPU 201, and is used when tone correction of print data is performed upon printing by transferring it to the image processing unit 203 with the CPU 201 upon printing.

As explained above, by virtue of the first embodiment, when the number of sheets of paper used for the printing of the test charts is small, and there is the possibility that, during printing of the test charts, paper will run out, the user is able to confirm whether or not to execute the printing prior to the printing of the test charts.

With this, an occurrence of a situation in which an interruption of printing processing occurs due to paper running out during printing of the test charts, and the printing for the charts performed so far being a waste, can be prevented.

### Second Embodiment

Next, explanation will be given for a second embodiment of the present invention. In the second embodiment, configuration is taken such that in cases where the user wishes to quickly complete the automatic tone correction, the user is able to print the charts for tone measurement, skipping the printing of the charts for process stabilization. Note, because the hardware configuration, and the like, of the image forming apparatus according to the second embodiment is the same as in the case of the previously described first embodiment, explanation is omitted.

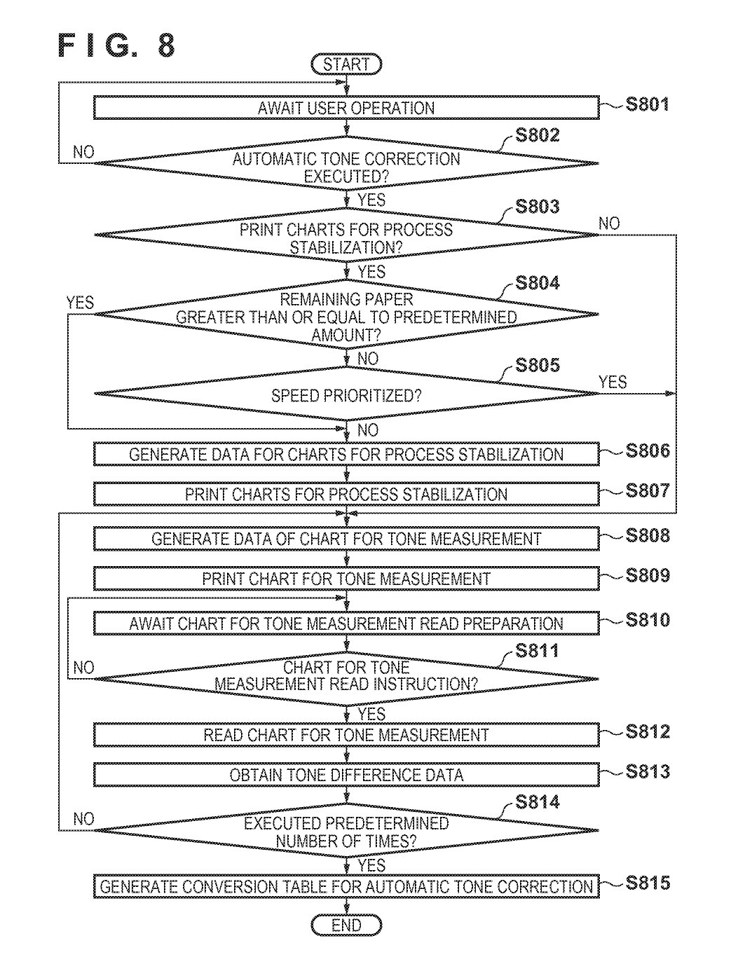

FIG. 8 is a flowchart for describing processing for printing charts for process stabilization and tone measurement charts, and generating a conversion table for tone correction based on the charts for tone measurement in the image forming apparatus according to a second embodiment of the present invention. Note, the processing shown in this flowchart is achieved by the CPU 201 executing a program stored in the ROM 202 or loaded into the DRAM 204.

In FIG. 8, because the processing of steps S801-S804, and steps S806-S815, is the same as the processing of steps S601-S604, and steps S607-S616 of the previously described FIG. 6, explanation is omitted.

In step S804, if the CPU 201 determines that the remaining paper amount is greater than or equal to a predetermined amount, the processing proceeds to step S806, and the CPU 201 prints the charts for process stabilization. On the other hand, when the CPU 201 determines that the remaining paper amount is not greater than or equal to the predetermined amount in step S804, the processing proceeds to step S805, the CPU 201 obtains a flag for “whether or not speed is prioritized upon automatic tone correction”, which is selected by the user and saved in the DRAM 204 beforehand. Here, when the CPU 201 determines that speed prioritization is set, the processing proceeds to step S808, print processing for the charts for process stabilization is skipped, and only the charts for tone measurement are printed. Meanwhile, when it is determined that speed prioritization is not set in step S805, the processing proceeds to step S806, the CPU 201 prints the charts for process stabilization.

By the second embodiment, cases where the user wishes to complete the automatic tone correction quickly, and cases where the user instead wishes to prioritize image quality are selectable in advance, and there is the effect that the automatic tone correction can be executed in accordance with the user wishes.

### Third Embodiment

Next, explanation will be given for a third embodiment of the present invention. In the third embodiment, explanation will be given for cases in which the print processing of the charts is switched in accordance with the number of remaining sheets of paper in cases where the number of remaining sheets of paper can be detected accurately. Note, because the hardware configuration, and the like, of the image forming apparatus according to the third embodiment is the same as in the case of the previously described first embodiment, explanation is omitted.

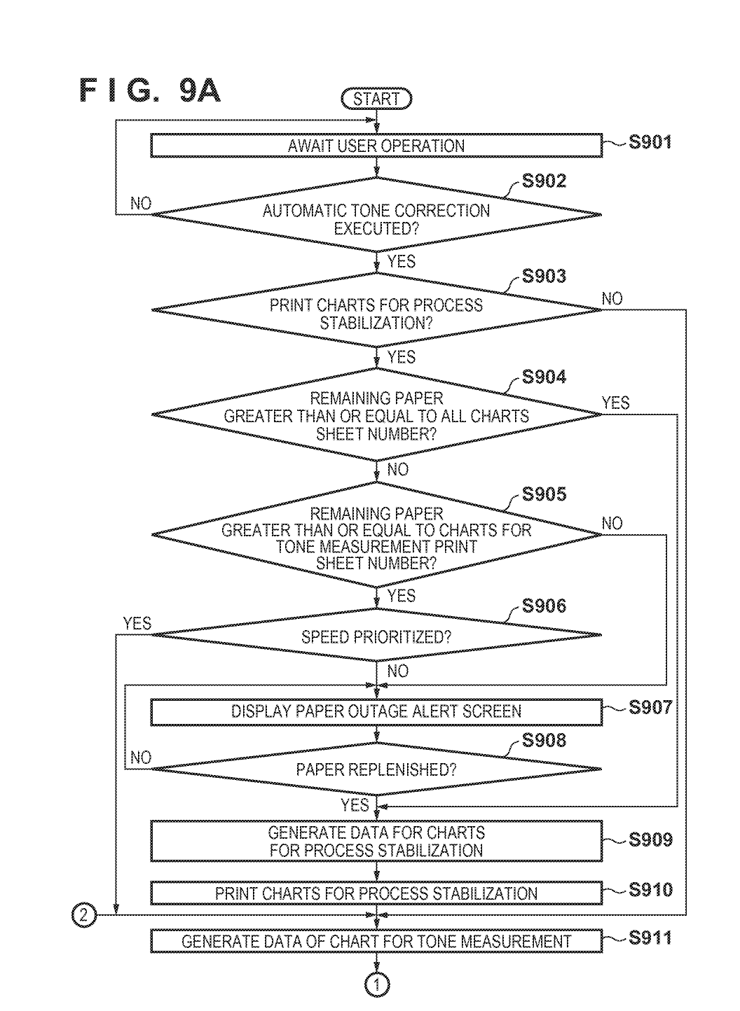

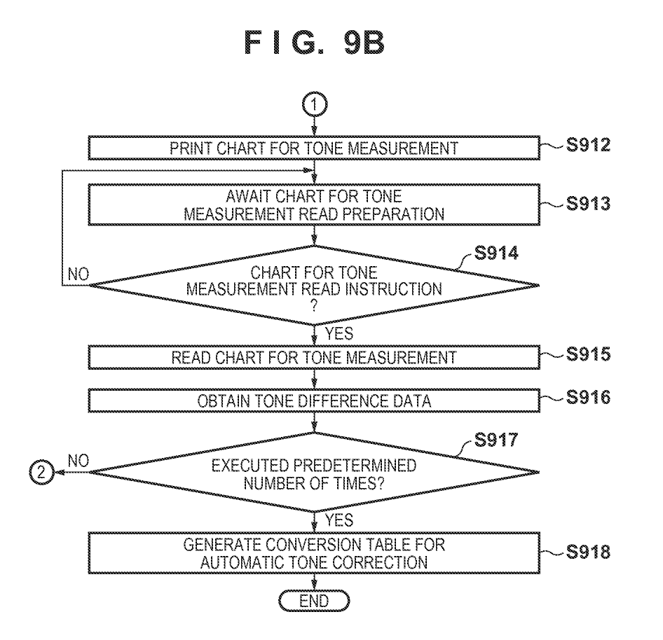

FIGS. 9A and 9B are flowcharts for describing processing for printing charts for process stabilization and tone measurement charts, and generating a conversion table for tone correction based on the charts for tone measurement in the image forming apparatus according to a third embodiment of the present invention. Note, the processing shown in this flowchart is achieved by the CPU 201 executing a program stored in the ROM 202 or loaded into the DRAM 204.

In FIGS. 9A and 9B, because the processing of steps S901-S903, and steps S909-S918, is the same as the processing of steps S601-S603, and steps S607-S616 of the previously described FIG. 6, their explanation will be omitted.

In the third embodiment, the CPU 201 counts the number of sheets every time the user prints to a sheet after feeding a maximum stackable number of sheets of paper to a paper feed cassette tray, and this counted value is saved to the DRAM 204. Then, by subtracting the counted value from the maximum stackable number of sheets, the current number of remaining sheets of paper is detected.

In step S903, the CPU 201 determines to print the charts for process stabilization, the processing proceeds to step S904, and the CPU 201 determines whether or not there are the necessary number of remaining sheets of paper in the paper feed cassette tray to perform the automatic tone correction for the all of the charts. When it is determined that there are greater than or equal to the number of sheets with which it is possible to print all of the charts (sum total of the number sheets printed for the charts for process stabilization and the number of sheets printed for the charts for tone measurement) in the paper feed cassette tray, the processing proceeds to step S909, and the data of the charts for process stabilization is generated, and printed.

Meanwhile, when the CPU 201 determines, in step S904, that the number of remaining sheets of paper are less than the number sheets printed for all of the charts, the processing proceeds to step S905, and the CPU 201 determines whether or not the number of remaining sheets is greater than or equal to the number of sheets for printing the charts for tone measurement. In step S905, if the CPU 201 determines that the number of remaining sheets is greater than or equal to the number of sheets for printing the charts for tone measurement, the processing proceeds to step S906, and when it determines that the number of remaining sheets is not greater than or equal to the number of sheets to be printed for the charts for tone measurement, the processing proceeds to step S907. In step S906, the CPU 201 determines whether or not speed prioritization is set similarly to in step S805 of the previously described FIG. 8, and if speed prioritization is set, the processing proceeds to step S911, and the processing proceeds to print processing for the charts for tone measurement. On the other hand, if speed prioritization is not set in step S906, the processing proceeds to step S907, and the CPU 201 prompts the user to replenish the paper by displaying an out of paper alerting screen on the display unit 304. Then, when the CPU 201 detects that the paper of the paper feed cassette tray is replenished by the user in step S908, it moves the processing to step S909, generates data for the charts for process stabilization and prints.

As explained above, by the third embodiment, even in a case where the remaining amount of paper is insufficient, configuration is taken so that in as many cases as possible the charts for process stabilization can be printed. Also, in cases where the number of remaining sheets is only enough that it is possible to print the charts for tone measurement, and speed prioritization is set, printing is only performed for the tone measurement charts, and the automatic tone correction can be completed quickly as is the wish of the user.

### Fourth Embodiment

Next, explanation will be given for a fourth embodiment of the present invention. In the fourth embodiment, in cases of speed prioritization, and where the sheet fed from the paper feed cassette tray is the last sheet, the printing of the charts for process stabilization is skipped if printing and reading of the chart for tone correction have already been executed a predetermined number of times. Thus, explanation will be given for an example in which, automatic tone correction being interrupted due to a paper outage is prevented as much as possible on speed prioritization. Note, because the hardware configuration, and the like, of the image forming apparatus according to the fourth embodiment is the same as in the case of the previously described first embodiment, explanation is omitted.

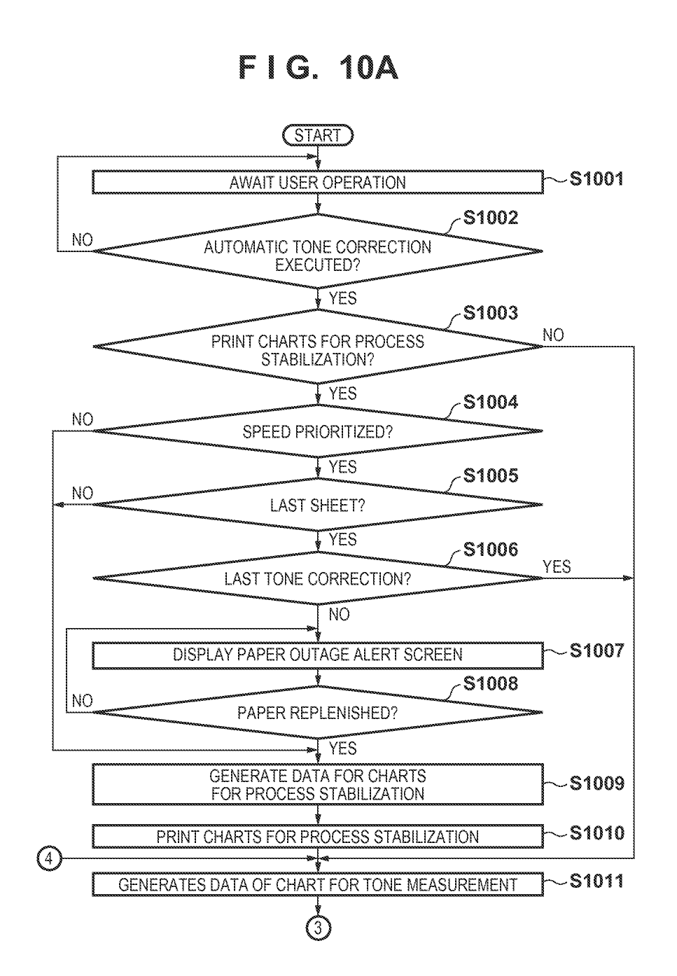

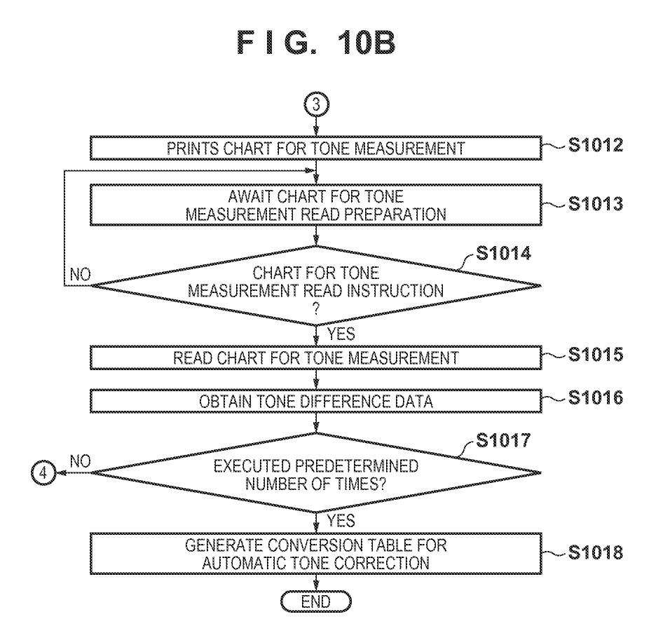

FIGS. 10A and 10B are flowchart for describing processing for printing charts for process stabilization and tone measurement charts, and generating a conversion table for tone correction based on the charts for tone measurement in the image forming apparatus according to according to a fourth embodiment of the present invention. Note, the processing shown in this flowchart is achieved by the CPU 201 executing a program stored in the ROM 202 or loaded into the DRAM 204.

In FIGS. 10A and 10B, because the processing of steps S1001-S1003, and steps S1009-S1018, is the same as the processing of steps S601-S603, and steps S607-S616 of the previously described FIG. 6, their explanation will be omitted.

When, in step S1003, the CPU 201 determines to print the charts for process stabilization, the processing proceeds to step S1004, and the CPU 201 determines whether or not speed prioritization is set similarly to in step S805 of the previously described FIG. 8. In cases where speed prioritization is set, the processing proceeds to step S1005, and the CPU 201 determines whether or not the fed sheet is the last sheet of the paper feed cassette tray, based on a detection signal of the paper outage detection sensors 120 (FIG. 1). In other words, it is determined whether or not the cassette paper feed tray ran out of paper due to the sheet being fed from the cassette tray. When it is determined that it is not the last sheet in step S1005, the processing proceeds to step S1009, and the processing proceeds to the print processing for the charts for process stabilization, but when it is determined that it is the final sheet, the processing proceeds to step S1006. In step S1006, the CPU 201 determines whether or not printing and reading of the chart for tone correction have been executed the predetermined number of times. When it is determined that the predetermined number of times have been executed, and that it is the final automatic tone correction, the processing proceeds to step S1011, and the CPU 201, skips the printing of the charts for process stabilization, and prints the charts for tone measurement. Meanwhile, when it is determined that it is not the final automatic tone correction in step S1006, the processing proceeds to step S1007, and the CPU 201 displays a paper outage alerting screen on the display unit 304 because there is insufficient paper similarly to in step S907 and step S908 of FIG. 9A. Then, in step S1008, replenishment of paper into the paper feed cassette tray is awaited, and when the paper is replenished, i.e. the paper outage in the paper feed cassette tray is cancelled, the processing proceeds to step S1009, and the processing proceeds to the print processing of the charts for process stabilization.

By the third embodiment, it is possible to avoid the automatic tone correction being interrupted by a paper outage upon speed prioritization as much as possible.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-116248, filed May 31, 2013, which is hereby incorporated by reference herein in its entirety.

What is claimed is:

1. An image forming apparatus, comprising:
a reading unit configured to read an image and generate image data of the image;
an image forming unit configured to form an image on a sheet based on image data;
a control unit configured to cause the image forming unit to form an image based on image data for tone correction after a preparation operation for respectively forming images on a predetermined number of sheets has been executed;
a correction unit configured to correct a tone of an image to be formed by the image forming unit, based on image data generated by the reading unit by reading an image of a sheet formed by the image forming unit;
a determination unit configured to determine whether or not a remaining number sheets that the image forming unit uses is greater than or equal to a predetermined number; and
a display unit configured to perform a display, in accordance with the result of the determination by the determination unit, in order to confirm with a user whether or not to execute the preparation operation.

2. The image forming apparatus according to claim 1, wherein, in a case where it is determined that the remaining number of sheets is not greater than or equal to the predetermined number by the determination unit, the display unit displays a screen in order to confirm with a user whether or not to execute the preparation operation.

3. The image forming apparatus according to claim 1, wherein, when it is instructed not to execute the preparation operation through a display by the display unit, the control unit controls so that image forming is performed by the image forming unit based on the image data for tone correction without executing the preparation operation.

4. The image forming apparatus according to claim 1, wherein the predetermined amount is an amount corresponding to a sum total of a number of sheets that are image formed by the image forming unit based on at least the image data for tone correction, and a number of sheets used in the preparation operation.

5. An image forming apparatus, comprising:
a reading unit configured to read an image and generate image data of the image;
an image forming unit configured to form an image on a sheet based on image data;
a control unit configured to cause the image forming unit to form an image based on image data for tone correction after a preparation operation for respectively forming images on a predetermined number of sheets has been executed;
a correction unit configured to correct a tone of an image to be formed by the image forming unit, based on image data generated by the reading unit by reading an image of a sheet formed by the image forming unit by the reading unit;
a determination unit configured to determine whether or not to perform the preparation operation in accordance with a setting of a user; and
a control unit configured to control so as to skip the preparation operation when the determination unit determines that the preparation operation is performed.

6. The image forming apparatus according to claim 5, wherein the determination unit determines whether or not to perform the preparation operation in accordance with a setting of a user in a case where prior to an image being formed by the image forming unit based on image data, a remaining number of sheets that the image forming unit uses is not greater than or equal to a predetermined number.

7. A method of controlling an image forming apparatus, the method comprising:
reading an image and generating image data of the image;
forming an image on a sheet based on image data;
correcting a tone of an image based on an image read in the reading, the image being an image of a sheet formed in the forming, based on image data for tone correction after a preparation operation for respectively forming images on a predetermined number of sheets has been executed;
determining whether or not a remaining number sheets used in the forming is greater than or equal to a predetermined number; and
performing a display, in accordance with the result of the determining, in order to confirm with a user whether or not to execute the preparation operation.

8. A non-transitory computer-readable storage medium storing a program for causing a computer to execute the method of controlling the image processing apparatus according to claim 7.
